(19) United States
(12) Patent Application Publication
(10) Pub. No.: US 2022/0222946 A1
(43) Pub. Date: Jul. 14, 2022

(54) TRAFFIC ENVIRONMENT RECOGNITION DEVICE AND VEHICLE CONTROL DEVICE

(71) Applicant: HONDA MOTOR CO., LTD., Tokyo (JP)

(72) Inventors: Rei Sakai, Saitama (JP); Umiaki Matsubara, Saitama (JP)

(73) Assignee: HONDA MOTOR CO., LTD., Tokyo (JP)

(21) Appl. No.: 17/441,442

(22) PCT Filed: Mar. 22, 2019
(86) PCT No.: PCT/JP2019/012159

§ 371 Date: Sep. 21, 2021

(51) Int. Cl. G06V 20/58; G06V 20/56; G06V 10/74; B60W 40/04; B60W 30/16; B60W 30/095; B60W 60/00

(52) U.S. Cl. CPC G06V 20/58; G06V 20/588; G06V 10/761; B60W 40/04; B60W 30/16; B60W 30/0956; B60W 2555/60; B60W 2420/42; B60W 2552/05; B60W 2554/4026; B60W 2554/4041; B60W 2554/4044; B60W 60/0015

(57) ABSTRACT

Provided are a traffic environment recognition device and the like capable of quickly recognizing a traffic environment in a traveling direction of a host vehicle. On the basis of surrounding situation data D_info, a vehicle control device 1 recognizes a moving object and a landmark within a predetermined range in a traveling direction of a host vehicle 3, and also recognizes a positional relationship between the moving object and the landmark. When a bicycle 21 is recognized as the moving object, a first moving object noun “bicycle” is selected, and when a guard fence 23 is recognized as the landmark, a first landmark noun “fence” is selected. Further, a positional relationship word “behind” indicating a positional relationship between the bicycle 21 and the guard fence is selected. Then, first scene data is created by associating “bicycle”, “behind”, and “fence” with each other.

### TECHNICAL FIELD

The present invention relates to a traffic environment recognition device and the like recognizing a traffic environment in a traveling direction of a host vehicle.

### BACKGROUND ART

Conventionally, as a traffic environment recognition device, what is described in Patent Literature 1 has been known. In this traffic environment recognition device, a maximum gradient value is calculated by a single regression analysis method using an acceleration spectrum on the basis of an acceleration of a host vehicle, and a minimum covariance value is calculated by a Gaussian distribution method on the basis of an inter-vehicle distance from another vehicle around the host vehicle. Then, a correlation map indicating a relationship between a logarithm of the maximum gradient value and a logarithm of the minimum covariance value is created, and it is determined whether or not there is a critical region in a traffic flow on the basis of the correlation map.

### CITATION LIST

### Patent Literature

Patent Literature 1: JP 5511984 B2

### SUMMARY OF INVENTION

### Technical Problem

In recent years, a vehicle control device executing automatic driving control of a host vehicle has been demanded. Such a vehicle control device recognizes a traffic environment including a moving object, a landmark, and the like in a traveling direction of the host vehicle and executes automatic driving control of the host vehicle. In view thereof, the traffic environment needs to be quickly recognized. In this regard, according to the conventional traffic environment recognition device, since the single regression analysis method using the acceleration spectrum and the Gaussian distribution method are used to recognize a traffic environment such as another vehicle around the host vehicle, a calculation time increases and a calculation load increases. This tendency is more remarkable as the number of traffic participants such as other vehicles is larger. As a result, there is a possibility that controllability in controlling automatic driving and the like may deteriorate.

The present invention has been made to solve the above-described problem, and an object of the present invention is to provide a traffic environment recognition device and the like capable of quickly recognizing a traffic environment in a traveling direction of a host vehicle.

### Solution to Problem

In order to achieve the above-described object, a traffic environment recognition device set forth in claim 1 includes: a surrounding situation data acquisition unit that acquires surrounding situation data indicating a surrounding situation in a traveling direction of a host vehicle; a recognition unit that recognizes a moving object and a landmark within a predetermined range in the traveling direction of the host vehicle and also recognizes a positional relationship between the moving object and the landmark, on the basis of the surrounding situation data; a storage unit that stores a plurality of moving object nouns that are respective names of a plurality of moving objects, a plurality of landmark nouns that are respective names of a plurality of landmarks, and a plurality of positional relationship words indicating a plurality of positional relationships between the moving objects and the landmarks, respectively; a first moving object noun selection unit that selects a first moving object noun indicating a predetermined first moving object, from among the plurality of moving object nouns, when the predetermined first moving object is recognized as the moving object; a first landmark noun selection unit that selects a first landmark noun indicating a predetermined first landmark, from among the plurality of landmark nouns, when the predetermined first landmark is recognized as the landmark present around the predetermined first moving object; a positional relationship word selection unit that selects a first positional relationship word indicating a positional relationship between the predetermined first moving object and the predetermined first landmark, from among the plurality of positional relationship words, when the positional relationship between the predetermined first moving object and the predetermined first landmark is recognized; and a traffic environment scene data creation unit that creates traffic environment scene data indicating a traffic environment scene in the traveling direction of the host vehicle, by associating the first moving object noun, the first landmark noun, and the first positional relationship word with each other, when the first moving object noun, the first landmark noun, and the first positional relationship word are selected.

According to this traffic environment recognition device, a moving object and a landmark in a traveling direction of a host vehicle are recognized and a positional relationship between the moving object and the landmark is recognized, on the basis of surrounding situation data indicating a surrounding situation within a predetermined range in the traveling direction of the host vehicle. Then, when a predetermined first moving object is recognized as the moving object, a first moving object noun indicating a predetermined first moving object is selected from among a plurality of moving object nouns, and when a predetermined first landmark is recognized as the landmark present around the predetermined first moving object, a first landmark noun indicating the predetermined first landmark is selected from among a plurality of landmark nouns. In addition, when a positional relationship between the predetermined first moving object and the predetermined first landmark is recognized, a first positional relationship word indicating the positional relationship between the predetermined first moving object and the predetermined first landmark is selected from among a plurality of positional relationship words. Then, when the first moving object noun, the first landmark noun, and the first positional relationship word are selected, traffic environment scene data indicating a traffic environment scene in the traveling direction of the host vehicle is created by associating the first moving object noun, the first landmark noun, and the first positional relationship word with each other.

As described above, under the condition that the predetermined first moving object and the predetermined first landmark are present within the predetermined range in the traveling direction of the host vehicle, the traffic environment scene data can be created only by associating the first moving object noun, the first landmark noun, and the first positional relationship word with each other. Accordingly, the traffic environment in the traveling direction of the host vehicle can be quickly recognized.

An invention set forth in claim 2 is the traffic environment recognition device according to claim 1, further including a second moving object noun selection unit that selects a second moving object noun indicating a predetermined second moving object, from among the plurality of moving object nouns, when the predetermined second moving object is recognized as the moving object other than the predetermined first moving object, wherein the storage unit further stores a plurality of positional relationship words indicating a plurality of positional relationships between the two moving objects, respectively, as the plurality of positional relationship words; when a positional relationship between the predetermined first moving object and the predetermined second moving object is recognized, the positional relationship word selection unit selects a second positional relationship word indicating the positional relationship between the predetermined first moving object and the predetermined second moving object from among the plurality of positional relationship words; and when the first moving object noun, the second moving object noun, and the second positional relationship word are selected, the traffic environment scene data creation unit further creates traffic environment scene data by associating the first moving object noun, the second moving object noun, and the second positional relationship word with each other.

According to this traffic environment recognition device, when a predetermined second moving object is recognized as the moving object as well as the predetermined first moving object, a second moving object noun indicating the predetermined second moving object is selected from among the plurality of moving object nouns. Further, when a positional relationship between the predetermined first moving object and the predetermined second moving object is recognized, a second positional relationship word indicating the positional relationship between the predetermined first moving object and the predetermined second moving object is selected from among the plurality of positional relationship words. Then, when the first moving object noun, the second moving object noun, and the second positional relationship word are selected, traffic environment scene data is further created by associating the first moving object noun, the second moving object noun, and the second positional relationship word with each other. As described above, under the condition that the predetermined first moving object and the predetermined second moving object are present in the traveling direction of the host vehicle, the traffic environment scene data can be further created only by associating the first moving object noun, the second moving object noun, and the second positional relationship word with each other. Accordingly, the traffic environment in the traveling direction of the host vehicle can be quickly recognized.

An invention set forth in claim 3 is the traffic environment recognition device according to claim 2, wherein the surrounding situation data acquisition unit acquires the surrounding situation data to include distance parameter data indicating a distance from the host vehicle, and the recognition unit recognizes the moving object and the landmark within the predetermined range on the basis of the distance parameter data.

According to this traffic environment recognition device, the moving object and the landmark located within the predetermined range are recognized on the basis of distance parameter data indicating a distance from the host vehicle. Accordingly, the traffic environment scene data can be appropriately created by appropriately setting the predetermined range.

An invention set forth in claim 4 is the traffic environment recognition device according to claim 3, wherein the distance parameter data is image data, and the recognition unit recognizes the predetermined first moving object and the predetermined first landmark located within the predetermined range on the basis of areas occupied by the predetermined first moving object and the predetermined first landmark, respectively, in the image data.

According to this traffic environment recognition device, the predetermined first moving object and the predetermined first landmark located within the predetermined range are recognized on the basis of areas occupied by the predetermined first moving object and the predetermined first landmark, respectively, in the image data. Accordingly, the predetermined first moving object and the predetermined first landmark located within the predetermined range can be recognized using a general image recognition method. As a result, the traffic environment scene data can be easily created.

An invention set forth in claim 5 is the traffic environment recognition device according to any one of claims 1 to 4, wherein the storage unit stores the plurality of positional relationship words to include a third positional relationship word indicating a positional relationship of the moving object with a road, and further stores a plurality of road type words indicating a plurality of road types, respectively, the traffic environment recognition device further includes: a road type recognition unit that recognizes a type of the road on which the predetermined first moving object is located on the basis of the surrounding situation data; and a first road type word selection unit that selects a first road type word indicating a predetermined first road type, from among the plurality of road type words, when the predetermined first road type is recognized as the type of the road on which the predetermined first moving object is located, when the predetermined first moving object is located on the road, the positional relationship word selection unit selects the third positional relationship word from among the plurality of positional relationship words, and when the first moving object noun, the first road type word, and the third positional relationship word are selected, the traffic environment scene data creation unit further creates traffic environment scene data by associating the first moving object noun, the first road type word, and the third positional relationship word with each other.

According to this traffic environment recognition device, when the predetermined first moving object is located on a road, a type of the road is recognized on the basis of the surrounding situation data. When a predetermined road type is recognized as the type of the road, a first road type word indicating the predetermined road type is selected from among a plurality of road type words. Further, when the predetermined first moving object is located on the road, a third positional relationship word is selected from among the plurality of positional relationship words. Then, when the first moving object noun, the first road type word, and the third positional relationship word are selected, traffic environment scene data is further created by associating the first moving object noun, the first road type word, and the third positional relationship word with each other. As described above, when the predetermined first moving object is located on the road in the predetermined road type, the traffic environment scene data can be further created only by associating the first moving object noun, the first road type word, and the third positional relationship word with each other. Accordingly, the traffic environment in the traveling direction of the host vehicle can be quickly recognized (note that the “road” in the present specification is not limited to a roadway or a sidewalk as long as a vehicle or a traffic participant can move thereon, including, for example, a railroad).

An invention set forth in claim 6 is the traffic environment recognition device according to any one of claims 1 to 4, wherein the surrounding situation data acquisition unit acquires a traveling direction of the predetermined first moving object, and the traveling direction of the predetermined first moving object is further associated in the traffic environment scene data.

According to this traffic environment recognition device, the traffic environment scene data is created by further associating the traveling direction of the predetermined first moving object. Accordingly, the traffic environment scene data can be created with an actual traffic environment being more reflected.

An invention set forth in claim 7 is the traffic environment recognition device according to any one of claims 1 to 6, further including: a risk model storage unit that stores a risk model defining a relationship of the traffic environment scene data with a risk to the host vehicle in the traffic environment; and a risk acquisition unit that acquires the risk corresponding to the traffic environment scene data using the risk model when the traffic environment scene data is created.

According to this traffic environment recognition device, when the traffic environment scene data is created, the risk corresponding to the traffic environment scene data is acquired using the risk model. Accordingly, the risk to the host vehicle in the traffic environment can be quickly acquired.

An invention set forth in claim 8 is the traffic environment recognition device according to claim 7, further including a risk storage unit that stores a first moving object risk that is a risk of the predetermined first moving object and a first landmark risk that is a risk of the predetermined first landmark, and a first position risk that is a risk of the positional relationship between the predetermined first moving object and the predetermined first landmark, wherein when the traffic environment scene data is created, in a case where the created traffic environment scene data does not exist in the risk model, the risk acquisition unit acquires the risk using the first moving object risk, the first landmark risk, and the first position risk.

According to this traffic environment recognition device, when the traffic environment scene data is created, even if the created traffic environment scene data does not exist in the risk model, the risk is acquired using the first moving object risk, the first landmark risk, and the first position risk. Accordingly, the risk to the host vehicle can be reliably acquired.

An invention set forth in claim 9 is the traffic environment recognition device according to claim 8, wherein the surrounding situation data acquisition unit acquires a traveling direction of the predetermined first moving object, and in a case where the relationship between the traffic environment scene data and the risk does not exist in the risk model, the risk acquisition unit acquires the risk by further using the traveling direction of the predetermined first moving object in addition to the first moving object risk, the first landmark risk, and the first position risk.

According to this traffic environment recognition device, when the traffic environment scene data does not exist in the risk model, the risk is acquired by further using the traveling direction of the predetermined first moving object in addition to the first moving object risk, the first landmark risk, and the first position risk. Accordingly, the risk to the host vehicle can be acquired more accurately.

An invention set forth in claim 10 is the traffic environment recognition device according to any one of claims 1 to 9, further including: a traffic regulation data storage unit that stores traffic regulation data; and a traffic regulation data acquisition unit that acquires the traffic regulation data corresponding to the traffic environment scene data, by referring to the traffic regulation data according to the traffic environment scene data, when the traffic environment scene data is created.

According to this traffic environment recognition device, when the traffic environment scene data is created, the traffic regulation data corresponding to the traffic environment scene data is acquired by referring to the traffic regulation data according to the traffic environment scene data. Accordingly, the traffic regulation data can be quickly acquired.

An invention set forth in claim 11 is the traffic environment recognition device according to claim 10, further including: a data communication unit that executes data communication with an external storage unit separate from the host vehicle, the external storage unit storing the traffic regulation data corresponding to a current position of the host vehicle; a current position acquisition unit that acquires the current position of the host vehicle; and a current position regulation data acquisition unit that acquires the traffic regulation data corresponding to the current position from the external storage unit by data communication when the current position of the host vehicle is acquired, wherein the traffic regulation data storage unit stores the traffic regulation data corresponding to the current position acquired by the current position regulation data acquisition unit.

According to this traffic environment recognition device, when the current position of the host vehicle is acquired, the traffic regulation data corresponding to the current position is acquired from the external storage unit by data communication and stored in the traffic regulation data storage unit. Accordingly, it is possible to realize a state where the traffic regulation data corresponding to the current position has been stored at a point in time when a control of a traveling state of the host vehicle is started.

An invention set forth in claim 12 is the traffic environment recognition device according to any one of claims 1 to 11, wherein the predetermined first moving object is a bicycle, and the recognition unit recognizes the bicycle in preference to the moving objects other than the bicycle.

In general, a bicycle frequently moves from a sidewalk to a roadway and vice versa. Thus, the bicycle has a higher risk than other moving objects that hardly move from the sidewalk to the roadway and vice versa, such as pedestrians and automobiles. In this regard, according to this traffic environment recognition device, the bicycle is recognized in preference to moving objects other than the bicycle. Accordingly, the above-described risk can be appropriately recognized.

A vehicle control device set forth in claim 13 includes: the traffic environment recognition device according to any one of claims 1 to 6; and a control unit that controls a traveling state of the host vehicle according to the traffic environment scene data.

According to this vehicle control device, the traveling state of the host vehicle is controlled according to the traffic environment scene data acquired quickly as described above. Accordingly, the traveling state of the host vehicle can be quickly and appropriately controlled according to the risk.

A vehicle control device set forth in claim 14 includes: the traffic environment recognition device according to any one of claims 7 to 9; and a control unit that controls a traveling state of the host vehicle according to the risk.

According to this vehicle control device, the traveling state of the host vehicle is controlled according to the risk acquired quickly as described above. Accordingly, the traveling state of the host vehicle can be quickly and appropriately controlled according to the risk.

A vehicle control device set forth in claim 15 includes: the traffic environment recognition device according to claim 10 or 11; and a control unit that controls a traveling state of the host vehicle according to the traffic regulation data.

According to this vehicle control device, the traveling state of the host vehicle is controlled according to the traffic regulation data. Accordingly, the traveling state of the host vehicle can be quickly and appropriately controlled while complying with the traffic regulation.

### BRIEF DESCRIPTION OF DRAWINGS

FIG. 1 is a diagram schematically illustrating a configuration of a traffic environment recognition device according to an embodiment of the present invention and a vehicle to which the traffic environment recognition device is applied.

FIG. 2 is a block diagram illustrating a functional configuration of a risk estimation device of the vehicle control device.

FIG. 3 is a diagram illustrating an example of a traffic environment of a host vehicle.

FIG. 4 is a plan view of the traffic environment of FIG. 3.

FIG. 5 is a diagram illustrating detection frames when image recognition is performed on image data of FIG. 3.

FIG. 6 is a diagram illustrating first scene data.

FIG. 7 is a diagram illustrating second scene data.

FIG. 8 is a diagram illustrating third scene data.

FIG. 9 is a diagram illustrating a first risk map.

FIG. 10 is a diagram illustrating a second risk map.

FIG. 11 is a diagram illustrating a third risk map.

FIG. 12 is a flowchart illustrating automatic driving control processing.

FIG. 13 is a flowchart illustrating traffic regulation data acquisition processing.

FIG. 14 is a diagram illustrating a communication state during execution of the traffic regulation data acquisition processing.

### DESCRIPTION OF EMBODIMENTS

Hereinafter, a traffic environment recognition device and a vehicle control device according to an embodiment of the present invention will be described with reference to the drawings. Note that the vehicle control device of the present embodiment also serves as the traffic environment recognition device. Thus, in the following description, while the vehicle control device is described, its function and configuration as the traffic environment recognition device will also be described.

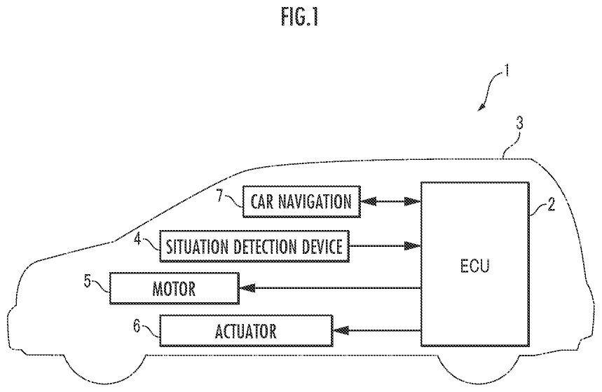

As illustrated in FIG. 1, the vehicle control device 1 is applied to a four-wheel automobile (hereinafter referred to as “a host vehicle”) 3, and includes an ECU 2. A situation detection device 4, a motor 5, an actuator 6, and a car navigation system (hereinafter referred to as “a car navigation”) 7 are electrically connected to the ECU 2.

The situation detection device 4 includes a camera, a millimeter wave radar, a LIDAR, a SONAR, a GPS, various sensors, and the like, and outputs surrounding situation data D_info indicating a current position of the host vehicle 3 and a surrounding situation (a traffic environment, a traffic participant, and the like) in a traveling direction of the host vehicle 3 to the ECU 2. The surrounding situation data D_info includes image data acquired by the camera and distance data measured by the LIDAR or the like.

As will be described later, the ECU 2 recognizes a traffic environment around the host vehicle 3 on the basis of the surrounding situation data D_info from the situation detection device 4, calculates a travel risk R_risk, and controls a traveling state of the host vehicle 3 based on the travel risk R_risk and the like. Note that in the present embodiment, the situation detection device 4 corresponds to a surrounding situation data acquisition unit and a current position acquisition unit, and the car navigation 7 corresponds to a data communication unit.

The motor 5 includes, for example, an electric motor, and the like. As will be described later, when a travel trajectory of the host vehicle 3 is determined, an output of the motor 5 is controlled by the ECU 2 such that the host vehicle 3 travels along the travel trajectory.

In addition, the actuator 6 includes a braking actuator, a steering actuator, and the like. As will be described later, when a travel trajectory of the host vehicle 3 is determined, an operation of the actuator 6 is controlled by the ECU 2 such that the host vehicle 3 travels along the travel trajectory.

Further, the car navigation 7 includes a display, a storage device, a wireless communication device, a controller (all not illustrated), and the like. In the car navigation 7, on the basis of a current position of the host vehicle 3, map data on surroundings of the current position of the host vehicle 3 is read out from among map data stored in the storage device, and the read-out map data is displayed on the display.

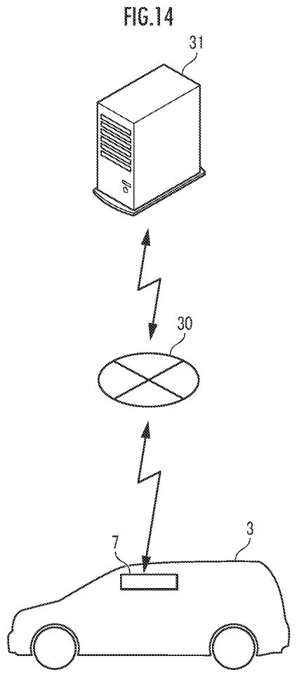

Further, the car navigation 7 executes wireless data communication with a car navigation of another vehicle, an external server 31 (see FIG. 14), and the like via the wireless communication device. As will be described later, when receiving traffic regulation data from the external server 31, the car navigation 7 outputs the traffic regulation data to the ECU 2.

Meanwhile, the ECU 2 includes a microcomputer including a CPU, a RAM, a ROM, an E2PROM, an I/O interface, various electric circuits (all not illustrated), and the like. The ECU 2 executes processing for calculating the travel risk R_risk and the like, on the basis of the surrounding situation data D_info and the like from the situation detection device 4 described above, as will be described below.

Note that, in the present embodiment, the ECU 2 corresponds to a recognition unit, a storage unit, a first moving object noun selection unit, a first landmark noun selection unit, a positional relationship word selection unit, a traffic environment scene data creation unit, a second moving object noun selection unit, a road type recognition unit, a first road type word selection unit, a risk model storage unit, a risk acquisition unit, a risk storage unit, a traffic regulation data storage unit, a traffic regulation data acquisition unit, a current position regulation data acquisition unit, and a control unit.

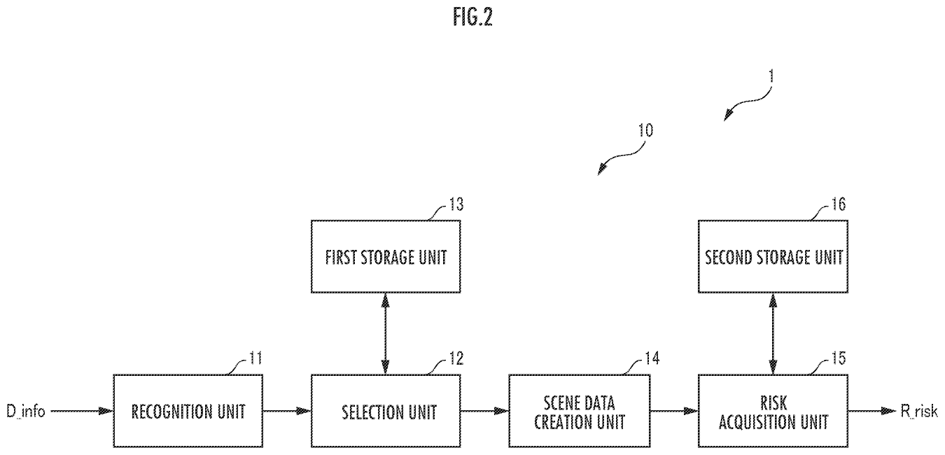

Next, a configuration of a risk estimation device 10 in the vehicle control device 1 will be described with reference to FIG. 2. As will be described below, the risk estimation device 10 estimates (acquires) a travel risk R_risk, which is a risk in a traffic environment while the host vehicle 3 is traveling, based on the surrounding situation data D_info.

As illustrated in FIG. 2, the risk estimation device 10 includes a recognition unit 11, a selection unit 12, a first storage unit 13, a scene data creation unit 14, a risk acquisition unit 15, and a second storage unit 16, and these elements 11 to 16 are specifically configured as the ECU 2.

Note that, in the present embodiment, the recognition unit 11 corresponds to the road type recognition unit, and the selection unit 12 corresponds to the first moving object noun selection unit, the first landmark noun selection unit, the positional relationship word selection unit, the second moving object noun selection unit, and the first road type word selection unit. Further, the first storage unit 13 corresponds to the storage unit, the scene data creation unit 14 corresponds to the traffic environment scene data creation unit, and the second storage unit 16 corresponds to the risk model storage unit and the risk storage unit.

The recognition unit 11 recognizes a moving object, a traffic participant, a landmark, and a road type present within a predetermined range (e.g., several tens of meters) in the traveling direction of the host vehicle 3, according to a predetermined image recognition method (e.g., a deep learning method), on the basis of the image data included in the surrounding situation data D_info.

In this case, a bicycle, a pedestrian, an automobile, and the like are recognized as moving objects and traffic participants, and a parked vehicle, a guard fence, and the like are recognized as landmarks. In addition, a roadway, a sidewalk, and the like are recognized as road types. Note that the “bicycle” in the present specification means a bicycle driven by a driver.

In addition, in the following description, the moving object recognized by the recognition unit 11 will be referred to as “a first moving object”, and the landmark recognized by the recognition unit 11 will be referred to as “a first landmark”. In this case, the first moving object corresponds to a moving object having the highest risk in a relationship with the host vehicle 3 and required to be recognized most preferentially by the recognition unit 11.

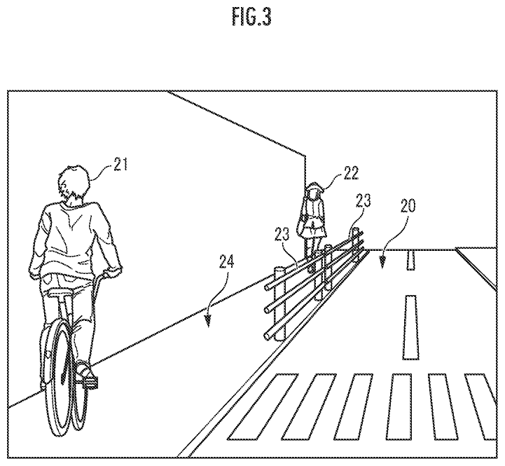

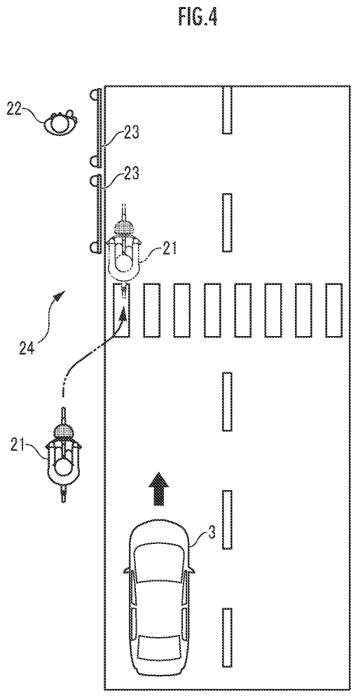

In the present embodiment, a traffic environment illustrated in FIGS. 3 and 4 will be described as an example. As illustrated in FIGS. 3 and 4, while the host vehicle 3 is traveling on a roadway 20, in a traffic environment where a bicycle 21 and a pedestrian 22 are present on a sidewalk 24 with a fence 23, the bicycle 21 is recognized as a first moving object, and the pedestrian 22 is recognized as a traffic participant (a second moving object). Further, the fence 23 is recognized as a first landmark, and the roadway 20 and the sidewalk 24 are recognized as road types.

On the other hand, although not illustrated, under the condition that only one pedestrian 22 is present with no bicycle 21, the pedestrian 22 is recognized as a first moving object. Further, although not illustrated, in a traffic environment where two or more pedestrians are present with no bicycle 21, a pedestrian closest to the host vehicle 3 is recognized as a first moving object, and the other pedestrians are recognized as traffic participants.

As described above, the bicycle 21 is recognized as a first moving object in preference to the pedestrian 22 because the bicycle 21 is regarded as a moving object having a higher risk than the pedestrian 22. That is, unlike the pedestrian 22 who is highly likely to move only on the sidewalk 24, the bicycle 21 is highly likely to move between the sidewalk 24 and the roadway 20, and accordingly, is highly likely to rush out of the sidewalk 24 to the roadway 20 at a relatively high speed.

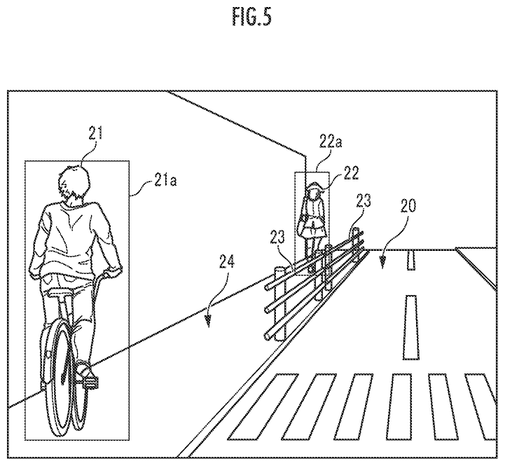

In addition, since moving objects and the like are recognized by the recognition unit 11 according to the predetermined image recognition method, a positional relationship between the first moving object and the traffic participant and the like are recognized based on their sizes in the image data. For example, as illustrated in FIG. 5, when a detection frame 21a of the bicycle 21 is larger than a detection frame 22a of the pedestrian 22 as a result of executing image recognition processing, it is recognized as a positional relationship between the bicycle 21 and the pedestrian 22 that the bicycle 21 is located in front of the pedestrian 22.

In addition, in a case where the recognition unit 11 recognizes the first moving object or the like as described above, positional relationships of the host vehicle 3 with the first moving object, the traffic participant, and the first landmark present in the traffic environment may be acquired on the basis of the distance data included in the surrounding situation data D_info. Further, positional relationships between the first moving object, the traffic participant, and the first landmark may be recognized using both the image data and the distance data included in the surrounding situation data D_info.

While recognizing the first moving object, the traffic participant, the first landmark, and the road type present in the traffic environment together with the positional relationships between the first moving object and the other objects as described above, the recognition unit 11 also recognizes whether or not the first moving object is traveling in the same direction as the host vehicle 3. Then, these recognition results are output from the recognition unit 11 to the selection unit 12.

When the recognition results are input from the recognition unit 11, the selection unit 12 acquires terms corresponding to the recognition results from among various nouns and positional relationship words stored in the first storage unit 13. The positional relationship words are terms indicating respective positional relationships of the first moving object with the other objects.

In the first storage unit 13, all of nouns indicating moving objects, nouns indicating traffic participants, nouns indicating landmarks, nouns indicating road types, and words indicating positional relationships are stored as English terms. As examples of moving objects or traffic participants, a bicycle, a pedestrian, and an automobile are stored as “bicycle”, “walker”, and “car”, respectively. In addition, as examples of landmarks, a parked vehicle, a guard fence, and a traffic light are stored as “parked vehicle”, “fence”, and “signal”, respectively. Further, as examples of road types, a roadway, a sidewalk, a crosswalk, and a railroad are stored as “drive way”, “sidewalk”, “cross-walk”, and “line”, respectively.

Meanwhile, as a word indicating a positional relationship between a first moving object and a traffic participant, a term indicating a state where the first moving object is located behind the traffic participant is stored as “behind”. In addition, a term indicating a state where a first moving object is located adjacent to a traffic participant is stored as “next to (or side)”, and a term indicating a state where a first moving object is located in front of a traffic participant is stored as “in front of”. Further, as words indicating positional relationships between a first moving object and a first landmark, the same terms are stored as described above.

On the other hand, as words indicating positional relationships between a first moving object and a road, a term indicating a state where the first moving object is moving on the road is stored as “on”, and a term indicating a state where the first moving object is moving across the road is stored as “across”.

Based on the above-described configuration, in the traffic environment illustrated in FIGS. 3 and 4, the selection unit 12 selects “bicycle”, “walker”, “fence”, and “sidewalk” as a first moving object, a traffic participant, a first landmark, and a road type, respectively. Note that, in the present embodiment, “bicycle” corresponds to a first moving object noun, “fence” corresponds to a first landmark noun, “walker” corresponds to a second moving object noun, and “sidewalk” corresponds to a first road type word.

In addition, as a word indicating a positional relationship between the first moving object and the traffic participant, “behind” is selected because the bicycle 21 as the first moving object is located behind the pedestrian 22 as the traffic participant. Further, as a word indicating a positional relationship between the first moving object and the first landmark, “behind” is selected because the bicycle 21 as the first moving object is located behind the guard fence as the first landmark. Note that, in the present embodiment, “behind” corresponds to a first positional relationship word and a second positional relationship word.

On the other hand, as a word indicating a positional relationship between the first moving object and the road, “on” is selected because the bicycle 21 as the first moving object is located on the sidewalk 24. Further, since the bicycle 21 as the first moving object is traveling in the same direction as the host vehicle 3, “same direction” is selected as a traveling direction of the first moving object. Note that, in the present embodiment, “on” corresponds to a third positional relationship word.

Then, when the nouns indicating the first moving object and the like, the positional relationship words, and the traveling direction of the first moving object are selected by the selection unit 12 as described above, these selection results are output to the scene data creation unit 14. Note that, in a case where one of a traffic participant and a first landmark is not present in a traffic environment in a traveling direction of the host vehicle 3, the selection unit 12 does not select a noun indicating the absent object and a word indicating a positional relationship of a first moving object with the absent object, and the noun and the word are not output to the scene data creation unit 14.

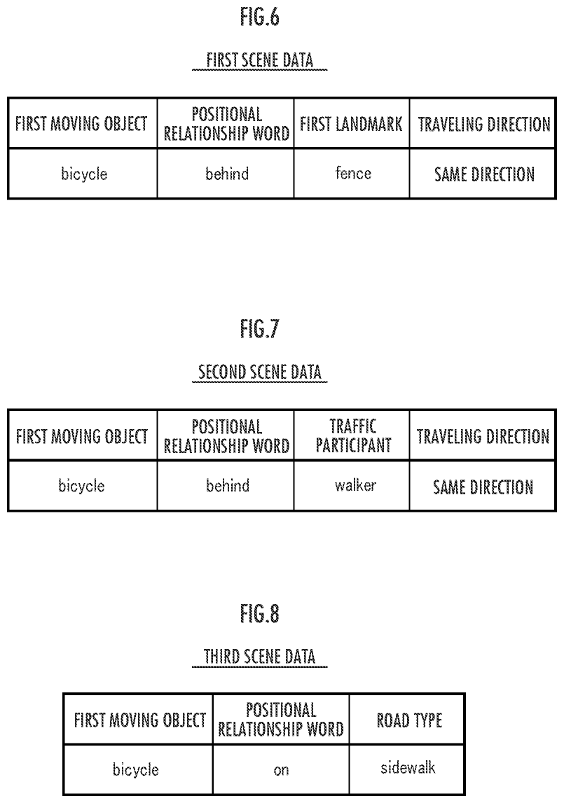

When the selection results are input from the selection unit 12, the scene data creation unit 14 creates scene data on the basis of the selection results. In this case, for example, when selection results in the traffic environment illustrated in FIGS. 3 and 4 are input from the selection unit 12, first to third scene data illustrated in FIGS. 6 to 8, respectively, are created. Note that, in the present embodiment, the first to third scene data correspond to traffic environment scene data.

As illustrated in FIG. 6, the first scene data is created as data in which “bicycle” as a first moving object, “behind” as a word indicating a positional relationship of the first moving object with respect to a first landmark, “fence” as the first landmark, and “same direction” as a traveling direction relationship between the first moving object and the host vehicle 3 are associated with each other.

In addition, as illustrated in FIG. 7, the second scene data is created as data in which “bicycle” as a first moving object, “behind” as a word indicating a positional relationship of the first moving object with respect to a traffic participant, “walker” as the traffic participant, and “same direction” as a traveling direction relationship between the first moving object and the host vehicle 3 are associated with each other.

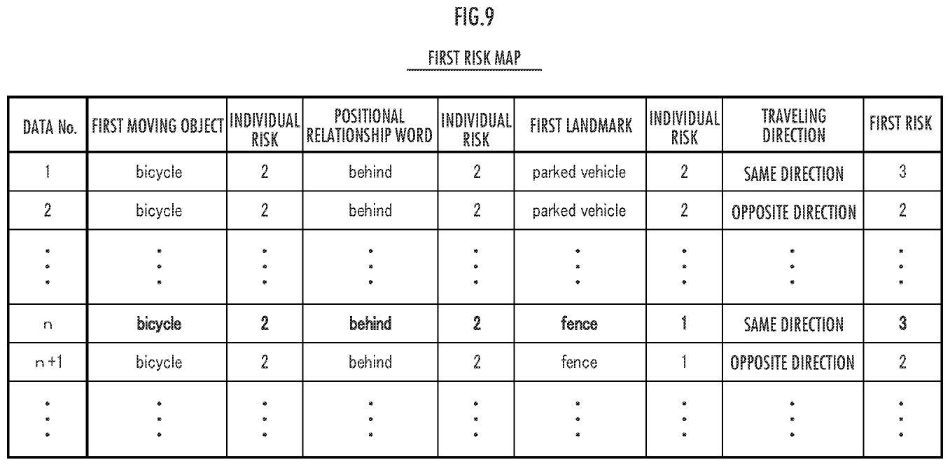

Further, as illustrated in FIG. 8, the third scene data is created as data in which “bicycle” as a first moving object, “on” as a word indicating a positional relationship of the first moving object with respect to a road, and “sidewalk” as a road type are associated with each other.

In a case where no first landmark is present in a traffic environment in a traveling direction of the host vehicle 3 as described above, a noun indicating a first landmark is not input from the selection unit 12 to the scene data creation unit 14, and accordingly, boxes for a first landmark and a positional relationship word in the first scene data are set blank. In addition, in a case where no traffic participant is present in a traffic environment in a traveling direction of the host vehicle 3, a noun indicating a traffic participant is not input from the selection unit 12, and accordingly, boxes for a traffic participant and a positional relationship word in the second scene data are set blank.

When the first to third scene data are created as described above, the first to third scene data are output from the scene data creation unit 14 to the risk acquisition unit 15. When the first to third scene data are input from the scene data creation unit 14, the risk acquisition unit 15 acquires (calculates) first to third risks Risk_1 to Risk_3 according to the first to third scene data as will be described below.

Specifically, the first risk Risk_1 is calculated by referring to a first risk map (risk model) illustrated in FIG. 9 according to the first scene data. For example, in the case of the above-described first scene data of FIG. 6, a combination of “bicycle” as a first moving object, “behind” as a positional relationship word, “fence” as a first landmark, and “same direction” as a traveling direction matches a combination of n-th data (n is an integer) marked in bold in the first risk map, and the first risk Risk_1 is calculated as value 3.

In addition, when the combination of the first moving object, the positional relationship word, the first landmark, and the traveling direction in the first scene data does not exist in the first risk map of FIG. 9, the risk acquisition unit 15 calculates the first risk Risk_1 according to the following method.

As illustrated in FIG. 9, an individual risk (first moving object risk) corresponding to the first moving object, an individual risk (first position risk) corresponding to the positional relationship word, and an individual risk corresponding to the first landmark are set in the first risk map. First, three individual risks corresponding to the first moving object, the positional relationship word, and the first landmark in the first scene data as described above are read out from the first risk map, and a provisional first risk Risk_tmp1 is calculated according to the following equation (1).

Risk_tmp1=(individual risk A×KA)×(individual risk B×KB)×(individual risk C×KC) (1)

In the above equation (1), the individual risk A represents an individual risk corresponding to the first moving object, and KA is a predetermined multiplication coefficient set in advance. In addition, the individual risk B represents an individual risk corresponding to the positional relationship word, and KB is a predetermined multiplication coefficient set in advance. Further, the individual risk C represents an individual risk corresponding to the first landmark, and KC is a predetermined multiplication coefficient set in advance.

After calculating the provisional first risk Risk_tmp1 according to the above equation (1), the provisional first risk Risk_tmp1 is converted into an integer by a predetermined method (e.g., a round-off method). Next, it is determined whether or not there is a risk in the traveling direction of the first moving object. When there is no risk in the traveling direction of the first moving object, the integer value of the provisional first risk Risk_tmp1 is set as the first risk Risk_1.

On the other hand, when there is a risk in the traveling direction of the first moving object, a value obtained by adding value 1 to the integer value of the provisional first risk Risk_tmp1 is set as the first risk Risk_1. In this case, the determination of the risk in the traveling direction of the first moving object is executed as will be specifically described below.

For example, in a case where it is assumed in FIG. 3 described above that the bicycle 21 as the first moving object is located in front of (inward of) the pedestrian 22, when the bicycle 21 is moving in an opposite direction to that of the host vehicle 3, that is, when the bicycle 21 is moving toward the host vehicle 3, it is determined that there is a risk in the traveling direction of the first moving object. On the other hand, when the bicycle 21 is moving in the same direction as the host vehicle 3, it is determined that there is no risk in the traveling direction of the first moving object.

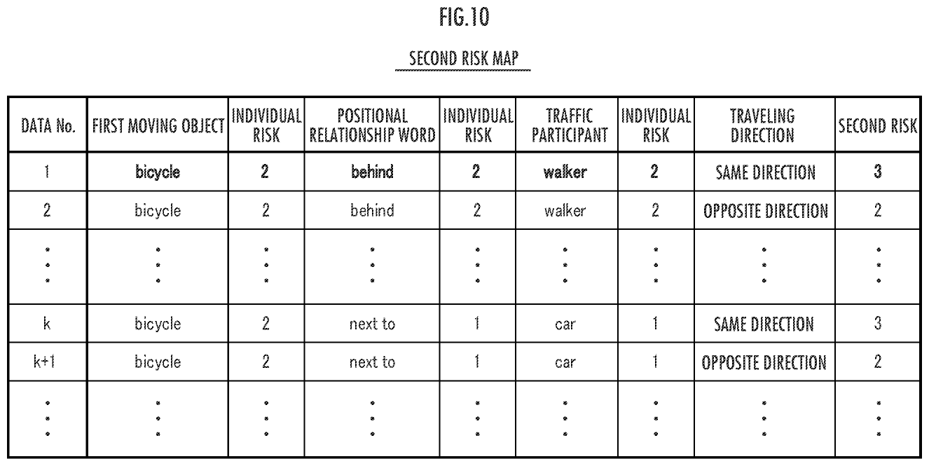

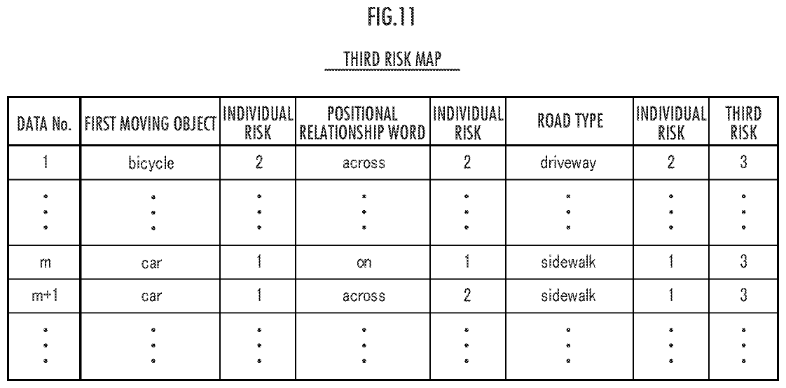

In addition, the second risk Risk_2 is calculated by referring to a second risk map (risk model) illustrated in FIG. 10 according to the second scene data. For example, in the case of the above-described second scene data of FIG. 7, a combination of “bicycle” as a first moving object, “behind” as a positional relationship word, “walker” as a traffic participant, and “same direction” as a traveling direction matches a combination of first data marked in bold in the second risk map, and the second risk Risk_2 is calculated as value 3.

In addition, when the combination of the first moving object, the positional relationship word, the traffic participant, and the traveling direction in the second scene data does not exist in the second risk map of FIG. 10, the second risk Risk_2 is calculated according to the same method as the method for calculating the first risk Risk_1 described above.

That is, three individual risks corresponding to the first moving object, the positional relationship word, and the traffic participant in the second scene data are read out from the second risk map, and a provisional second risk Risk_tmp2 is calculated according to the following equation (2).

Risk_tmp2=(individual risk A×KA)×(individual risk B×KB)×(individual risk D×KD) (2)

In the above equation (2), the individual risk D represents an individual risk corresponding to the traffic participant, and KD is a predetermined multiplication coefficient set in advance. After calculating the provisional second risk Risk_tmp2 according to the above equation (2), the provisional second risk Risk_tmp2 is converted into an integer by the above-described predetermined method.

Next, it is determined whether or not there is a risk in the traveling direction of the first moving object. When there is no risk in the traveling direction of the first moving object, the integer value of the provisional second risk Risk_tmp2 is set as the second risk Risk_2. On the other hand, when there is a risk in the traveling direction of the first moving object, a value obtained by adding value 1 to the integer value of the provisional second risk Risk_tmp2 is set as the second risk Risk_2.

Further, the third risk Risk_3 is calculated by referring to a third risk map (risk model) illustrated in FIG. 11 according to the third scene data. In this case, when a combination of the third scene data, i.e., “bicycle” as a first moving object, “on” as a positional relationship word, and “sidewalk” as a road type, matches a combination of data in the third risk map, a third risk Risk_3 corresponding to the combination is read out.

On the other hand, when the combination of “bicycle” as a first moving object, “on” as a positional relationship word, and “sidewalk” as a road type does not match a combination of data in the third risk map, for example, in the case of the above-described third scene data of FIG. 8, the third risk Risk_3 is calculated according to a method that is substantially the same as the method for calculating the first risk Risk_1 and the second risk Risk_2 described above.

That is, three individual risks corresponding to the first moving object, the positional relationship word, and the road type in the third scene data are read out from the third risk map, and a provisional third risk Risk_tmp3 is calculated according to the following equation (3).

Risk_tmp3=(individual risk A×KA)×(individual risk B×KB)×(individual risk E×KE) (3)

In the above equation (3), the individual risk E represents an individual risk corresponding to the road type, and KE is a predetermined multiplication coefficient set in advance.

After calculating the provisional third risk Risk_tmp3 according to the above equation (3), the provisional third risk Risk_tmp3 is converted into an integer by the above-described predetermined method. Then, the integer value of the provisional third risk Risk_tmp3 is set as the third risk Risk_3.

After calculating the first to third risks Risk_1˜3 as described above, the risk acquisition unit 15 finally calculates a travel risk R_risk on the basis of the first to third risks Risk_1˜3 according to a predetermined calculation method (e.g., a weighted average calculation method and a map search method). According to the above-described method, the travel risk R_risk is calculated by the risk estimation device 10.

Note that the travel risk R_risk may be estimated as a risk involving a predetermined space including not only a first moving object but also a landmark or a traffic participant, or may be estimated as a risk involving a first moving object itself. For example, when there is no other traffic participant besides the first moving object, the travel risk R_risk may be estimated as a risk only involving the first moving object, and when there is scene data with which the travel risk R_risk can be estimated as a risk of the first moving object among the first to third scene data, the travel risk R_risk may be estimated as a risk only involving the first moving object. In this way, the estimation may be changed as to which space of the road there is a risk on.

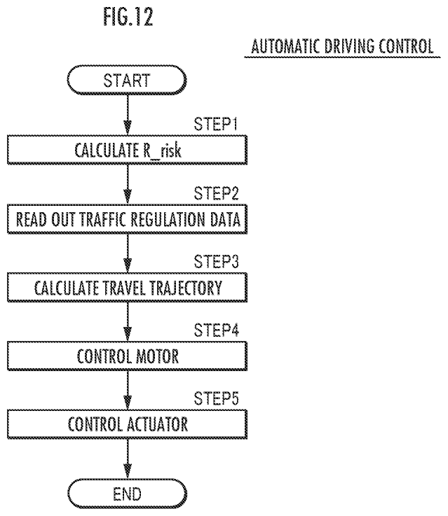

Next, automatic driving control processing by the vehicle control device 1 of the present embodiment will be described with reference to FIG. 12. The automatic driving control processing is executed for automatic driving control of the host vehicle 3 using a travel risk R_risk as will be described below, and is executed by the ECU 2 at a predetermined control cycle. Note that various values calculated in the following description are stored in the E2PROM of the ECU 2.

As illustrated in FIG. 12, first, a travel risk R_risk is calculated (FIG. 12/STEP 1). Specifically, the travel risk R_risk is calculated by the ECU2 according to the same calculation method of the risk estimation device 10 as described above.

Next, traffic regulation data is read out from the E2PROM according to the first to third scene data described above (FIG. 12/STEP 2). The traffic regulation data is acquired through traffic regulation data acquisition processing, which will be described later, and stored in the E2PROM.

Next, travel trajectory calculation processing is executed (FIG. 12/STEP 3). In this processing, a future travel trajectory of the host vehicle 3 is calculated as time-series data in a two-dimensional coordinate system using a predetermined calculation algorithm on the basis of the travel risk R_risk calculated as described above, the traffic regulation data, and the surrounding situation data D_info. That is, the travel trajectory is calculated as time-series data defining a position on an x-y coordinate axis, a speed in an x-axis direction, and a speed in a y-axis direction of the host vehicle 3.

Next, the motor 5 is controlled for the host vehicle 3 to travel along the travel trajectory (FIG. 12/STEP 4). Next, the actuator 6 is controlled for the host vehicle 3 to travel along the travel trajectory (FIG. 12/STEP 5). Then, this processing ends.

By executing the automatic driving control processing as described above, a traveling state of the host vehicle 3 is controlled based on the travel risk R_risk and the traffic regulation data. For example, when the travel risk R_risk is high, the host vehicle 3 travels to change a traveling line to a lane close to the center lane while decelerating. On the other hand, when the travel risk R_risk is low, the host vehicle 3 travels while maintaining a vehicle speed and a traveling line.

In the present embodiment, as described above, the first to third scene data as traffic environment scene data are created in English in the form of so-called “subject”, “adjective”, and “predicate”. Therefore, the traffic regulation data can be used as it is, and when the traffic regulation data is in a state where a feature point is recognized through natural language processing or the like, the traffic regulation data can be retrieved according to the created traffic environment scene data.

For example, while the host vehicle 3 is traveling in Japan, if the second scene data is a combination of “bicycle” as a first moving object, “behind” as a positional relationship word, and “bicycle” as a traffic participant (second moving object), that is, if the first moving object “bicycle” is located behind the traffic participant “bicycle”, since both the first moving object “bicycle” and the traffic participant “bicycle” are small vehicles, traffic regulation data indicating “when overtaking another vehicle, it is basically required to change a track to the right side and pass by the right side of the vehicle to be overtaken”, which is stipulated under Article 28 of Road Traffic Act in Japan, is retrieved. Accordingly, it can be estimated that the first moving object “bicycle” is highly likely to rush out onto a traveling lane on its right.

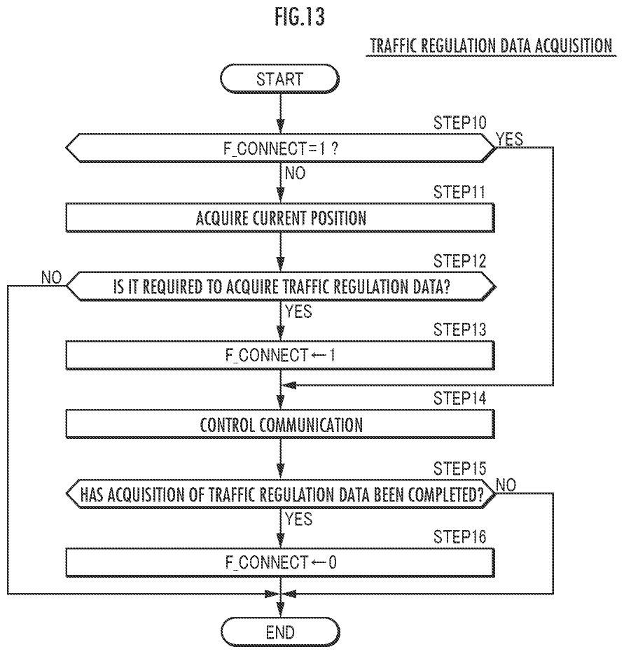

Next, traffic regulation data acquisition processing by the vehicle control device 1 of the present embodiment will be described with reference to FIG. 13. The traffic regulation data acquisition processing is for acquiring traffic regulation data as will be described below, and is executed by the ECU 2 at a predetermined control cycle. Note that the traffic regulation data acquisition processing is executed only when the host vehicle 3 is activated.

As illustrated in FIG. 13, first, it is determined whether or not a communication control flag F_CONNECT is “1” (FIG. 13/STEP 10). When the determination is negative (FIG. 13/STEP 10 . . . NO), and communication control processing, which will be described later, has not been executed at a control timing of the previous cycle, a current position is acquired by the GPS (FIG. 13/STEP 11).

Next, it is determined whether or not it is required to acquire traffic regulation data (FIG. 13/STEP 12). In this determination processing, on the basis of the current position acquired as described above, when traffic regulation data corresponding to the current position is not stored in the E2PROM of the ECU 2, it is determined that it is required to acquire traffic regulation data. Otherwise, it is determined that it is not required to acquire traffic regulation data.

When the determination is negative (FIG. 13/STEP 12 . . . NO) and traffic regulation data corresponding to the current position is stored in the E2PROM of the ECU 2, this processing ends.

On the other hand, when the determination is affirmative (FIG. 13/STEP 12 . . . YES) and traffic regulation data corresponding to the current position is not stored in the E2PROM of the ECU 2, it is determined that it is required to execute communication control processing for acquiring the traffic regulation data, and the communication control flag F_CONNECT is set to “1” to indicate it (FIG. 13/STEP 13).

When the communication control flag F_CONNECT is set to “1” as described above, or when the above-described determination is affirmative (FIG. 13/STEP 10 . . . YES) and the communication control processing, which will be described below, has been executed at the control timing of the previous cycle, the communication control processing is successively executed (FIG. 13/STEP 14).

In this communication control processing, as illustrated in FIG. 14, wireless data communication is executed between the ECU 2 and the external server 31 via a wireless communication device (not illustrated) of the car navigation 7 and a wireless communication network 30. The external server 31 stores traffic regulation data corresponding to the current position. Based on the above-described configuration, by executing the communication control processing, the traffic regulation data stored in the external server 31 is received by the car navigation 7, and then the traffic regulation data is input to the ECU 2.

After the communication control processing is executed as described above, it is determined whether or not the acquisition of the traffic regulation data has been completed (FIG. 13/STEP 15). When the determination is negative (FIG. 13/STEP 15 . . . NO) and the acquisition of the traffic regulation data has not been completed, the processing ends.

On the other hand, when the determination is affirmative (FIG. 13/STEP 15 . . . YES) and the acquisition of the traffic regulation data has been completed, that is, when the traffic regulation data has been stored in the E2PROM of the ECU 2, it is determined that it is required to terminate the communication control processing, and the communication control flag F_CONNEC is set to “0” to indicate it (FIG. 13/STEP 16). Then, the processing ends.

As described above, according to the vehicle control device 1 of the present embodiment, the first to third scene data are created on the basis of the surrounding situation data D_info. Then, the first to third risks Risk_1 to Risk_3 are calculated by referring to the first to third risk maps according to the first to third scene data, respectively, and the travel risk R_risk is finally calculated based on the first to third risks Risk_1 to Risk_3. Then, the traveling state of the host vehicle 3 is controlled based on the travel risk R_risk.

In this case, since the first scene data is created by associating the first moving object noun, the first landmark noun, the positional relationship word, and the traveling direction with each other, the first scene data can be quickly created. Likewise, since the second scene data is created by associating the first moving object noun, the positional relationship word, the traffic participant noun, and the traveling direction with each other, and the third scene data is created by associating the first moving object noun, the positional relationship word, and the road type word with each other, the second scene data and the third scene data can also be quickly created. In this way, the traffic environment in the traveling direction of the host vehicle 3 can be quickly recognized.

In addition, the positional relationships between the bicycle 21 as the first moving object, the guard fence 23 as the first landmark, and the pedestrian 22 as the traffic participant can be easily acquired using a general image recognition method, thereby easily creating the first to third scene data.

Further, since the first to third risks Risk_1 to Risk_3 are calculated by referring to the first to third risk maps according to the first to third scene data created quickly and easily as described above, respectively, and the travel risk R_risk is finally calculated on the basis of the first to third risks Risk_1 to Risk_3, the travel risk R_risk can also be acquired quickly and easily.

In addition, even when the first scene data does not exist in the first risk model, the first risk Risk_1 is acquired using the individual risk of the first moving object, the individual risk of the first landmark, the individual risk of the positional relationship word, and the traveling direction of the first moving object, and the second risk Risk_2 and the third risk Risk_3 are also acquired by the same method. In this way, the travel risk R_risk for the host vehicle 3 can be reliably acquired.

In addition, since the traffic regulation data for the current position is acquired according to the first to third scene data, and the traveling state of the host vehicle 3 is controlled based on the travel risk R_risk and the traffic regulation data, the host vehicle 3 can be caused to travel quickly and appropriately in response to the risk while complying with the traffic regulation at the current position.

In addition, since the traffic regulation data corresponding to the current position is acquired from the external server 31 by wireless data communication and stored in the ECU 2 while the host vehicle 3 is activated, it is possible to realize a state where the traffic regulation data corresponding to the current position has been stored at a point in time when the control of the traveling state of the host vehicle 3 is started.

Note that, although the embodiment is an example in which the travel risk R_risk is calculated according to the first to third risks Risk_1 to Risk_3, the travel risk R_risk may be calculated according to at least one of the first to third risks Risk_1 to Risk_3.

In addition, although the embodiment is an example in which the traveling state of the host vehicle 3 is controlled according to the travel risk R_risk, the traveling state of the host vehicle 3 may be controlled according to at least one of the first to third risks Risk_1 to Risk_3.

Further, although the embodiment is an example in which the first scene data is configured as data in which the first moving object noun, the first landmark noun, the first positional relationship word, and the traveling direction of the first moving object are associated with each other, the first scene data may be configured as data in which the first moving object noun, the first landmark noun, and the first positional relationship word are associated with each other.

On the other hand, although the embodiment is an example in which the second scene data is configured as data in which the first moving object noun, the second moving object noun, the second positional relationship word, and the traveling direction of the first moving object are associated with each other, the second scene data may be configured as data in which the first moving object noun, the second moving object noun, and the second positional relationship word are associated with each other.

In addition, although the embodiment is an example in which the car navigation system 7 is used as the data communication unit, the data communication unit of the present invention is not limited thereto as long as the data communication unit executes data communication with an external storage unit separate from the host vehicle. For example, a wireless communication circuit or the like separate from the car navigation system may be used.

Further, although the embodiment is an example in which the first to third risk maps are used as the risk models, the risk models of the present invention are not limited thereto as long as the risk models define relationships between traffic environment scene data and risks. For example, graphs defining relationships between traffic environment scene data and risks may be used.

Meanwhile, although the embodiment is an example in which the traveling state of the host vehicle 3 is controlled based on the travel risk R_risk and the traffic regulation data, in a traffic environment (e.g. a circuit or a field) in which there is no problem even if the traffic regulation is ignored, the traveling state of the host vehicle 3 may be controlled based only on the travel risk R_risk.

### REFERENCE SIGNS LIST

1 Vehicle control device, traffic environment recognition device
2 ECU (recognition unit, storage unit, first moving object noun selection unit, first landmark noun selection unit, positional relationship word selection unit, traffic environment scene data creation unit, second moving object noun selection unit, road type recognition unit, first road type word selection unit, risk model storage unit, risk acquisition unit, risk storage unit, traffic regulation data storage unit, traffic regulation data acquisition unit, current position regulation data acquisition unit, control unit)
3 Host vehicle
4 Situation detection device (surrounding situation data acquisition unit, current position acquisition unit)
7 Car navigation system (data communication unit)
11 Recognition unit (road type recognition unit)
12 Selection unit (first moving object noun selection unit, first landmark noun selection unit, positional relationship word selection unit, second moving object noun selection unit, first road type word selection unit)
13 First storage unit (storage unit)
14 Scene data creation unit (traffic environment scene data creation unit)
15 Risk acquisition unit
16 Second storage unit (risk model storage unit, risk storage unit)
21 Bicycle (first moving object, moving object)
22 Pedestrian (second moving object, moving object)
23 Guard fence (first landmark, landmark)
D_info Surrounding situation data
bicycle First moving object noun fence First landmark noun walker Second moving object noun behind First positional relationship word, second positional relationship word on Third positional relationship word
Risk_1 First risk (risk)
Risk_2 Second risk (risk)
Risk_3 Third risk (risk)
R_risk Travel risk (risk)

1. A traffic environment recognition device comprising:
a surrounding situation data acquisition unit that acquires surrounding situation data indicating a surrounding situation in a traveling direction of a host vehicle;
a recognition unit that recognizes a moving object and a landmark within a predetermined range in the traveling direction of the host vehicle and also recognizes a positional relationship between the moving object and the landmark, based on the surrounding situation data;
a storage unit that stores a plurality of moving object nouns that are respective names of a plurality of moving objects, a plurality of landmark nouns that are respective names of a plurality of landmarks, and a plurality of positional relationship words indicating a plurality of positional relationships between the moving objects and the landmarks, respectively;
a first moving object noun selection unit that selects a first moving object noun indicating a predetermined first moving object, from among the plurality of moving object nouns, in a case where the predetermined first moving object is recognized as the moving object;
a first landmark noun selection unit that selects a first landmark noun indicating a predetermined first landmark, from among the plurality of landmark nouns, in a case where the predetermined first landmark is recognized as the landmark present around the predetermined first moving object;
a positional relationship word selection unit that selects a first positional relationship word indicating a positional relationship between the predetermined first moving object and the predetermined first landmark, from among the plurality of positional relationship words, in a case where the positional relationship between the predetermined first moving object and the predetermined first landmark is recognized; and
a traffic environment scene data creation unit that creates traffic environment scene data indicating a traffic environment scene in the traveling direction of the host vehicle, by associating the first moving object noun, the first landmark noun, and the first positional relationship word with each other, in a case where the first moving object noun, the first landmark noun, and the first positional relationship word are selected.

2. The traffic environment recognition device according to claim 1, further comprising
a second moving object noun selection unit that selects a second moving object noun indicating a predetermined second moving object, from among the plurality of moving object nouns, in a case where the predetermined second moving object is recognized as the moving object other than the predetermined first moving object, wherein
the storage unit further stores a plurality of positional relationship words indicating a plurality of positional relationships between the two moving objects, respectively, as the plurality of positional relationship words,
in a case where a positional relationship between the predetermined first moving object and the predetermined second moving object is recognized, the positional relationship word selection unit selects a second positional relationship word indicating the positional relationship between the predetermined first moving object and the predetermined second moving object from among the plurality of positional relationship words, and
in a case where the first moving object noun, the second moving object noun, and the second positional relationship word are selected, the traffic environment scene data creation unit further creates traffic environment scene data by associating the first moving object noun, the second moving object noun, and the second positional relationship word with each other.

3. The traffic environment recognition device according to claim 2, wherein
the surrounding situation data acquisition unit acquires the surrounding situation data to include distance parameter data indicating a distance from the host vehicle, and
the recognition unit recognizes the moving object and the landmark located within the predetermined range based on the distance parameter data.

4. The traffic environment recognition device according to claim 3, wherein
the distance parameter data is image data, and
the recognition unit recognizes the predetermined first moving object and the predetermined first landmark located within the predetermined range based on areas occupied by the predetermined first moving object and the predetermined first landmark, respectively, in the image data.

5. The traffic environment recognition device according to claim 1, wherein
the storage unit stores the plurality of positional relationship words to include a third positional relationship word indicating a positional relationship of the moving object with a road, and further stores a plurality of road type words indicating a plurality of road types, respectively,
the traffic environment recognition device further comprises:
a road type recognition unit that recognizes a type of the road on which the predetermined first moving object is located based on the surrounding situation data; and
a first road type word selection unit that selects a first road type word indicating a predetermined first road type, from among the plurality of road type words, in a case where the predetermined first road type is recognized as the type of the road on which the predetermined first moving object is located,
in a case where the predetermined first moving object is located on the road, the positional relationship word selection unit selects the third positional relationship word from among the plurality of positional relationship words, and
in a case where the first moving object noun, the first road type word, and the third positional relationship word are selected, the traffic environment scene data creation unit further creates traffic environment scene data by associating the first moving object noun, the first road type word, and the third positional relationship word with each other.

6. The traffic environment recognition device according to claim 1, wherein
the surrounding situation data acquisition unit acquires a traveling direction of the predetermined first moving object, and
the traveling direction of the predetermined first moving object is further associated in the traffic environment scene data.

7. The traffic environment recognition device according to claim 1, further comprising:
a risk model storage unit that stores a risk model defining a relationship of the traffic environment scene data with a risk to the host vehicle in the traffic environment; and
a risk acquisition unit that acquires the risk corresponding to the traffic environment scene data using the risk model in a case where the traffic environment scene data is created.

8. The traffic environment recognition device according to claim 7, further comprising
a risk storage unit that stores a first moving object risk that is a risk of the predetermined first moving object, a first landmark risk that is a risk of the predetermined first landmark, and a first position risk that is a risk of the positional relationship between the predetermined first moving object and the predetermined first landmark, wherein
when the traffic environment scene data is created, in a case where the created traffic environment scene data does not exist in the risk model, the risk acquisition unit acquires the risk using the first moving object risk, the first landmark risk, and the first position risk.

9. The traffic environment recognition device according to claim 8, wherein
the surrounding situation data acquisition unit acquires a traveling direction of the predetermined first moving object, and
in a case where the relationship between the traffic environment scene data and the risk does not exist in the risk model, the risk acquisition unit acquires the risk by further using the traveling direction of the predetermined first moving object in addition to the first moving object risk, the first landmark risk, and the first position risk.

10. The traffic environment recognition device according to claim 1, further comprising:
a traffic regulation data storage unit that stores traffic regulation data; and
a traffic regulation data acquisition unit that acquires the traffic regulation data corresponding to the traffic environment scene data, by referring to the traffic regulation data according to the traffic environment scene data, in a case where the traffic environment scene data is created.

11. The traffic environment recognition device according to claim 10, further comprising:
a data communication unit that executes data communication with an external storage unit provided outside the host vehicle and storing the traffic regulation data corresponding to a current position of the host vehicle;
a current position acquisition unit that acquires the current position of the host vehicle; and
a current position regulation data acquisition unit that acquires the traffic regulation data corresponding to the current position from the external storage unit by data communication in a case where the current position of the host vehicle is acquired, wherein
the traffic regulation data storage unit stores the traffic regulation data corresponding to the current position acquired by the current position regulation data acquisition unit.

12. The traffic environment recognition device according to claim 1, wherein
the predetermined first moving object is a bicycle, and
the recognition unit recognizes the bicycle in preference to the moving objects other than the bicycle.

13. A vehicle control device comprising:
the traffic environment recognition device according to claim 1; and
a control unit that controls a traveling state of the host vehicle according to the traffic environment scene data.

14. A vehicle control device comprising:
the traffic environment recognition device according to claim 7; and
a control unit that controls a traveling state of the host vehicle according to the risk.

15. A vehicle control device comprising:
the traffic environment recognition device according to claim 10; and
a control unit that controls a traveling state of the host vehicle according to the traffic regulation data.
